(19) United States
(12) Patent Application Publication
(10) Pub. No.: US 2024/0040248 A1
(43) Pub. Date: Feb. 1, 2024

(54) Video Processing Method and Apparatus, and Electronic Device

(71) Applicant: ARCSOFT CORPORATION LIMITED, Hangzhou, Zhejiang (CN)

(72) Inventors: Jin WANG, Hangzhou, Zhejiang (CN); Junjie ZOU, Hangzhou, Zhejiang (CN); Yushan HUANG, Hangzhou, Zhejiang (CN)

(21) Appl. No.: 18/268,616

(22) PCT Filed: Aug. 10, 2022
(86) PCT No.: PCT/CN2022/111355

§ 371 Date: Jun. 21, 2023

(30) Foreign Application Priority Data
Jun. 10, 2021 (CN) 202110648208.4

(51) Int. Cl. H04N 23/68

(52) U.S. Cl. CPC H04N 23/6812; H04N 23/683

(57) ABSTRACT

The present invention discloses a video processing method and apparatus, and an electronic device. The video processing method includes: controlling N camera units in one electronic device to simultaneously acquire N paths of video data, wherein the N camera units are simultaneously turned on under a control of a same control unit in the electronic device, and N is an integer not less than 2; obtaining a processing result by processing a plurality of paths of video data in the N paths of video data; and displaying the processing result on a display screen of the electronic device. By means of the present invention, it is possible to solve the technical problem in the related art that a plurality of cameras are usually turned on at different times respectively in a camera switching mode, such that data collected by the plurality of cameras cannot be acquired at the same time.

### CROSS-REFERENCE TO RELATED APPLICATION

The present application claims the priority of Chinese Application No. 2021106482084, filed in the Chinese Patent Office on Jun. 10, 2021, and entitled “Video Processing Method and Apparatus, and Electronic Device”, the entire contents of which are herein incorporated by reference.

### TECHNICAL FIELD

The present invention relates to an image processing technology, and in particular, to a video processing method and apparatus, and an electronic device.

### BACKGROUND

Electronic devices having a plurality of cameras, including but not limited to, mobile phones, tablet computers, unmanned aerial vehicles and the like, are more and more widely used due to their adaptability to different scenarios and different photographing requirements. However, the plurality of cameras are generally turned on at different times respectively in a camera switching mode at present, such that data collected by the plurality of cameras cannot be acquired at the same time.

Therefore, it is necessary to propose a video processing technology, which can simultaneously acquire data collected by a plurality of cameras and process the collected data as needed.

### SUMMARY

Embodiments of the present invention provide a video processing method and apparatus, and an electronic device, so as to at least solve the technical problem in the related art that a plurality of cameras are usually turned on at different times respectively in a camera switching mode, such that data collected by the plurality of cameras cannot be acquired at the same time.

According to one aspect of the embodiments of the present invention, a video processing method is provided, including: controlling N camera units in one electronic device to simultaneously acquire N paths of video data, wherein the N camera units are simultaneously turned on under a control of a same control unit in the electronic device, and N is an integer not less than 2; obtaining a processing result by processing a plurality of paths of video data in the N paths of video data; and displaying the processing result on a display screen of the electronic device.

Optionally, the step of obtaining a processing result by processing a plurality of paths of video data in the N paths of video data includes: selecting one of the N camera units as a basic camera unit, correcting the video data acquired by the basic camera unit, and acquiring basic information of the basic camera unit; correcting, according to the basic information of the basic camera unit, M paths of video data that are acquired by the remaining M camera units in the N camera units; and taking the corrected video data of the basic camera unit and the M camera units as the processing result.

Optionally, the step of correcting, according to the basic information of the basic camera unit, M paths of video data that are acquired by the remaining M camera units in the N camera units includes: respectively acquiring second posture information of the M camera units according to the basic information of the basic camera unit and first posture information of the M camera units; and respectively correcting the M paths of video data according to internal parameters, the first posture information and the second posture information of the M camera units.

Optionally, the step of correcting, according to the basic information of the basic camera unit, M paths of video data that are acquired by the remaining M camera units in the N camera units includes: respectively acquiring relative information of the M camera units according to the basic information of the basic camera unit and first posture information of the M camera units; and respectively correcting the M paths of video data according to the internal parameters and the relative information of the M camera units.

Optionally, the above video processing method further includes: calibrating the M camera units with the basic camera unit as a reference, and acquiring external parameters and internal parameters of the M camera units and the basic camera unit; and determining the first posture information of the M camera units according to the first posture information of the basic camera unit, and the external parameters of the M camera units and the basic camera unit.

Optionally, the method for correcting the video data acquired by the basic camera unit and the M paths of video data acquired by the M camera units comprises at least one of image stabilization processing method, deblurring processing method, denoising processing method, and brightening processing method.

Optionally, the basic information of the basic camera unit comprises at least one of motion compensation information, a motion posture trajectory, and posture changes in previous and subsequent frames.

Optionally, the internal parameters comprise a focal length and an optical center position.

Optionally, the step of calibrating the M camera units with the basic camera unit as the reference, and acquiring the external parameters of the M camera units and the basic camera unit includes: with the basic camera unit as the reference, calculating a relative position relationship between the M camera units and the basic camera unit, so as to acquire the external parameters of the M camera units.

Optionally, the external parameters comprise direction features and position features, the direction features of the camera units are recorded by using a rotation matrix, and the position features of the camera units are recorded by using a translation matrix.

Optionally, the basic information of the basic camera unit is obtained by a motion sensor, and the motion sensor comprises at least one of a gyroscope, an accelerometer and a magnetometer.

Optionally, the step of correcting the video data acquired by the basic camera unit includes: performing discrete sampling on a motion posture trajectory of the basic camera unit within a continuous time period, so as to obtain a point spread function or a blur kernel, and then obtaining deblurred video data by means of deconvolution.

Optionally, the step of obtaining a processing result by processing the N paths of video data includes: performing splicing processing on at least two paths of video data in the N paths of video data, and taking the spliced video data as the processing result.

According to another aspect of the embodiments of the present invention, an image processing method is provided, including: collecting a third original image and a fourth original image, wherein the third original image is one of an original target image and a background image, and the fourth original image is the other of the original target image and the background image; obtaining an input image according to the third original image and the fourth original image; training an initial image generation network to construct a trained image generation network, wherein the image generation network is trained with a template image as a reference object, and the template image is a target image which is obtained by using any of the above image processing methods and in which a background is removed; and inputting the input image into the trained image generation network, so as to obtain the target image with the background removed.

Optionally, the step of obtaining the input image according to the third original image and the fourth original image includes: performing local brightness alignment processing on the third original image and the fourth original image, and taking a processing result as the input image.

According to another aspect of the embodiments of the present invention, a video processing apparatus is provided, including: a control unit, configured to control N camera units in an electronic device to be simultaneously turned on, so as to acquire N paths of video data; a processing unit, configured to obtain a processing result by processing a plurality of paths of video data in the N paths of video data; and a display unit, configured to display the processing result on a display screen of the electronic device.

Optionally, the processing unit includes: a first processing sub-unit, configured to select one of the N camera units as a basic camera unit, correct the video data acquired by the basic camera unit, and acquire basic information of the basic camera unit; a second processing sub-unit, configured to correct, according to the basic information of the basic camera unit, M paths of video data that are acquired by the remaining M camera units in the N camera units; and a result acquisition unit, configured to take the corrected video data of the basic camera unit and the M camera units as the processing result.

Optionally, the second processing sub-unit includes: a second posture acquisition unit, configured to respectively acquire second posture information of the M camera units according to the basic information of the basic camera unit and first posture information of the M camera units; and a correction unit, configured to respectively correct the M paths of video data according to internal parameters, the first posture information and the second posture information of the M camera units.

Optionally, the second processing sub-unit includes: a relative information acquisition unit, configured to respectively acquire relative information of the M camera units according to the basic information of the basic camera unit and first posture information of the M camera units; and a correction unit, configured to respectively correct the M paths of video data according to the internal parameters and the relative information of the M camera units.

Optionally, the second processing sub-unit further includes: a calibration unit, configured to calibrate the M camera units with the basic camera unit as a reference, and acquire external parameters and internal parameters of the M camera units and the basic camera unit; and a first posture acquisition unit, configured to determine the first posture information of the M camera units according to the first posture information of the basic camera unit, and the external parameters of the M camera units and the basic camera unit.

Optionally, the processing unit includes: a splicing unit, configured to perform splicing processing on at least two paths of video data in the N paths of video data, and take the spliced video data as the processing result.

According to another aspect of the embodiments of the present invention, a non-transitory computer readable storage medium is also provided, including a stored program, wherein when the program runs, a device where the non-transitory computer readable storage medium is located is controlled to execute any one of the above video processing methods.

According to another aspect of the embodiments of the present invention, an electronic device is also provided, including: a processor; and a memory for storing executable instructions of the processor, wherein the processor is configured to execute any one of the above video processing methods by means of executing the executable instructions.

In the embodiments of the present invention, it is possible to solve the technical problem in the related art that a plurality of cameras are usually turned on at different times respectively in a camera switching mode, such that data collected by the plurality of cameras cannot be acquired at the same time by means of executing the following steps: controlling N camera units in one electronic device to simultaneously acquire N paths of video data, wherein the N camera units are simultaneously turned on under a control of a same control unit in the electronic device, and N is an integer not less than 2; obtaining a processing result by processing a plurality of paths of video data in the N paths of video data; and displaying the processing result on a display screen of the electronic device.

### BRIEF DESCRIPTION OF THE DRAWINGS

The drawings described herein are used to provide further understanding of the present invention and constitute a part of the present application. The exemplary embodiments of the present invention and descriptions thereof are used to explain the present invention, but do not constitute improper limitations of the present invention. In the drawings:

FIG. 1 is a flowchart of an optional video processing method according to an embodiment of the present invention;

FIG. 2 is a specific flowchart of step S102 in the video processing method according to an embodiment of the present invention;

FIG. 3 is a flowchart of steps S200-S206 applied to three-path video image stabilization according to an embodiment of the present invention;

FIG. 4 is a flowchart of steps S200-S206 applied to three-path video deblurring according to an embodiment of the present invention;

FIG. 5 is a flowchart of steps S200-S206 applied to three-path video denoising according to an embodiment of the present invention; and

FIG. 6 is a structural block diagram of an optional video processing apparatus according to an embodiment of the present invention.

### DETAILED DESCRIPTION OF THE EMBODIMENTS

In order that those skilled in the art may better understand the solutions of the present invention, a clear and complete description of technical solutions in the embodiments of the present invention will be given below, in combination with the drawings in the embodiments of the present invention. Apparently, the embodiments described below are merely a part, but not all, of the embodiments of the present invention. All of other embodiments, obtained by those of ordinary skill in the art based on the embodiments of the present invention without any creative effort, fall into the protection scope of the present invention.

It should be noted that, the terms “first” and “second” and the like in the specification, claims and the above drawings of the present invention are used for distinguishing similar objects, and are not necessarily used for describing a specific sequence or precedence order. It should be understood that the sequences used in this way may be interchanged under appropriate circumstances, so that the embodiments of the present invention described herein may be implemented in a sequence other than those illustrated or described herein. Furthermore, the terms “including” and “having”, and any variations thereof are intended to cover non-exclusive inclusions, for example, processes, methods, systems, products or devices including a series of steps or units are not necessarily limited to those clearly listed steps or units, but may include other steps or units that are not clearly listed or are inherent to these processes, methods, products or devices. The steps shown in the flowcharts of the drawings may be executed in a computer system, such as a group of computer-executable instructions. Furthermore, although a logical sequence is shown in the flowchart, in some cases, the steps shown or described may be executed in an sequence other than herein.

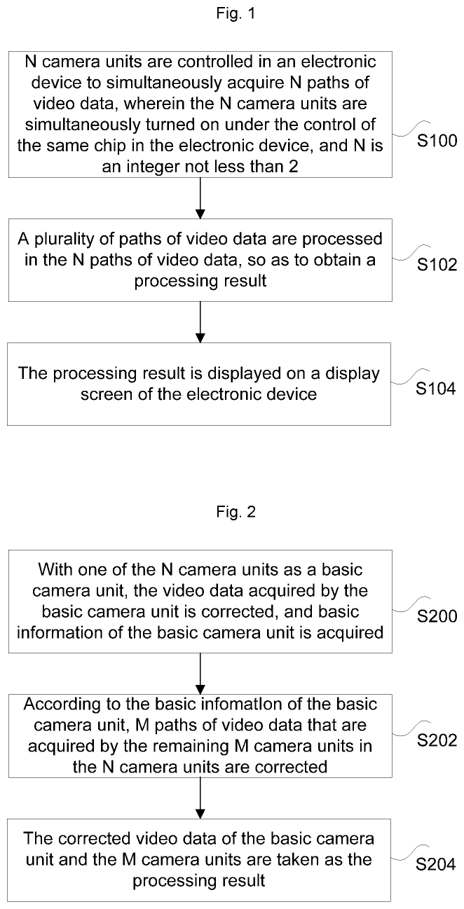

Referring to FIG. 1, it is a flowchart of an optional video processing method according to an embodiment of the present invention. The method includes the following steps:
S100, controlling N camera units in one electronic device to simultaneously acquire N paths of video data, wherein the N camera units are simultaneously turned on under a control of a same control unit in the electronic device, and N is an integer not less than 2.

In an optional embodiment, the electronic device may be a video camera, a smart phone, a mobile phone, a computer, a tablet computer, a desktop computer, a television, a vehicle, a remote control aircraft, a healthcare device, a set-top box and the like, which have a plurality of camera units. The N camera units may be of the same type, for example, all are common RGB cameras; and may also be of different types, such as combinations of two or more of a common RGB camera, an ultra-wide-angle camera, a wide-angle camera, a telephoto camera, an infrared camera, a depth camera and other cameras. The same control unit may be the same chip, the same sensor, and so on.

S102, obtaining a processing result by processing a plurality of paths of video data in the N paths of video data; and
S104, displaying the processing result on a display screen of the electronic device.

By means of the video processing method that is implemented by the steps S100-S104, N paths of video data may be acquired simultaneously, and the N camera units are only controlled by the same control unit, such that the cost and the volume of the electronic device may be reduced.

In the related art, if a user wants to display his/her own portrait and a background at the same time, he/she usually takes a selfie after selecting a scenario. However, in this way, since the user is relatively close to the camera when taking the selfie, a selfie portrait will occupy a relatively large proportion in an entire picture, which is easy to shield the selected scenario, and thus it is difficult to present the selfie portrait and the background with a better effect. By using the above video processing method, the user may turn on front and rear cameras at the same time when using the electronic device, so as to acquire a front scenario and a rear scenario at the same time, thus enriching video information. Moreover, the user may add his/her own expressions and languages while photographing the rear scenario, so that the mood, feeling, author information and the like of the user are recorded in real time with the scenarios, and it is unnecessary to worry about the problems of shielding the selected scenario and data asynchronization.

Reference may be made to FIG. 2 for a specific processing method of the above step S102, which includes the following steps:
S200, with one of the N camera units as a basic camera unit, correcting the video data acquired by the basic camera unit, and acquiring basic information of the basic camera unit.

In an optional embodiment, if the N camera units are all image cameras, a camera with a greater angle of field of view may be selected as the basic camera unit, so as to contain external information as much as possible; if the N camera units contain a depth camera, when applied to portrait photographing, depth reconstruction and other photographing scenarios that rely more on depth information, the depth camera may be selected as the basic camera unit; and if the N camera units contain an infrared camera, when applied to a night vision environment, infrared tracking and other photographing scenarios that rely more on infrared information, the infrared camera may be selected as the basic camera unit. Only some examples of selecting the basic camera unit are given above, and those skilled in the art may select one of the N camera units as the basic camera unit according to actual application scenarios.

In different application scenarios, the video data acquired by the basic camera unit may be corrected in different modes, for example, image stabilization processing, denoising processing, deblurring processing, brightening processing, and so on. Correspondingly, different information may be acquired as the basic information, for example, during image stabilization processing, motion compensation information of the basic camera unit may be acquired as the basic information; during deblurring processing, a motion posture trajectory of the basic camera unit may be acquired as the basic information; and during denoising processing, posture changes in previous and subsequent frames of the basic camera unit may be acquired as the basic information. Of course, the above description is only an example of the basic information that is acquired according to different application scenarios, and those skilled in the art may also acquire reasonable basic information according to actual needs.

In an optional embodiment, the basic information of the basic camera unit may be acquired by using an information acquisition unit (e.g., a motion posture sensor such as a gyroscope, an accelerometer and a magnetometer).

S202, correcting, according to the basic information of the basic camera unit, M paths of video data that are acquired by the remaining M camera units in the N camera units.

In an optional embodiment, the step S202 includes:
S2020, respectively acquiring second posture information of the M camera units according to the basic information of the basic camera unit and first posture information of the M camera units; and
S2022, respectively correcting the M paths of video data according to internal parameters, the first posture information and the second posture information of the M camera units.

In another optional embodiment, the step S202 includes:
S2030, respectively acquiring relative information of the M camera units according to the basic information of the basic camera unit and first posture information of the M camera units; and
S2032, respectively correcting the M paths of video data according to the internal parameters and the relative information of the M camera units.

In an optional embodiment, prior to the step S2022 or S2032, step S2021 is further included: calibrating the M camera units with the basic camera unit as a reference, and acquiring external parameters and internal parameters of the M camera units and the basic camera unit; and determining the first posture information of the M camera units according to the first posture information of the basic camera unit, and the external parameters of the M camera units and the basic camera unit.

In an optional embodiment, the step of calibrating the M camera units, and acquiring the external parameters and the internal parameters of the M camera units and the basic camera unit includes: with the basic camera unit as the reference, calculating a relative position relationship between the M camera units and the basic camera unit, so as to acquire the external parameters of the M camera units, and to acquire the internal parameters of the M camera units and the basic camera unit at the same time. Specifically, the external parameters include direction features and position features, the direction features of the camera units may be recorded by using a rotation matrix, and the position features of the camera units may be recorded by using a translation matrix. The internal parameters include a focal length, an optical center position, etc.

S204, taking the corrected video data of the basic camera unit and the M camera units as the processing result.

By means of the above steps S200-S208, it is not necessary to equip the M camera units with respective information acquisition units to acquire M pieces of basic information, but only one basic camera unit needs to be selected, and the basic information of the basic camera unit is acquired by means of an information acquisition unit corresponding to the basic camera unit, such that it is possible to correct the M paths of video data that are acquired by the remaining M camera units in the N camera units, and image stabilization, deblurring, denoising, brightening and other processing of a plurality of paths of concurrent videos are realized. Therefore, the number of information acquisition units in the electronic device may be reduced, and the volume, cost and calculation amount of the electronic device may be further reduced, thus reducing requirements on the performance and power consumption of the electronic device.

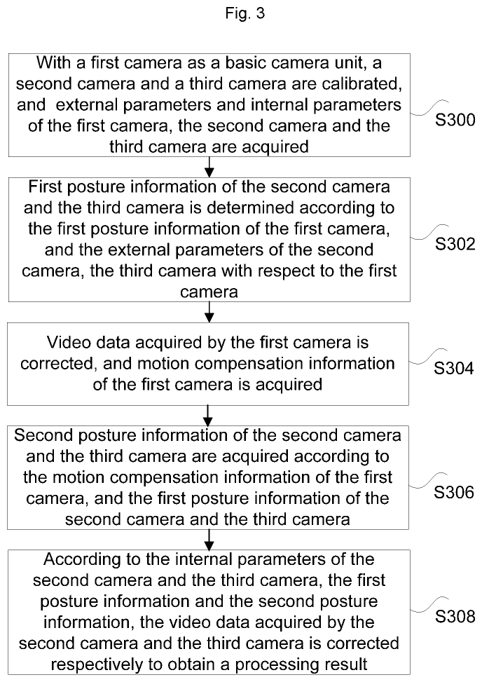

In order to help understanding, an electronic device with three camera units is taken as an example below, so as to describe, in conjunction with FIGS. 3-5, specific steps of respectively applying the above steps S200-S206 to application scenarios such as image stabilization processing, deblurring and denoising of three paths of concurrent videos.

Referring to FIG. 3, it is a flowchart of the above steps S200-S206 applied to three-path video image stabilization according to an embodiment of the present invention, which includes the following steps:

S300, with a first camera as a basic camera unit, calibrating a second camera and a third camera, and acquiring external parameters and internal parameters of the first camera, the second camera and the third camera.

In an optional embodiment, posture information of the three cameras during calibration are respectively denoted as P_{c}¹, P_{c}² and P_{c}³. With the first camera as a basic camera, the first camera is calibrated based on the second camera and the third camera, relative posture information P₁₂=P_{c}²*P_{c}¹^{^{−1}} and P₁₃=P_{c}³*P_{c}¹^{^{−1}} are determined as the external parameters, and focal lengths, optical center positions and other internal parameters of the first camera, the second camera and the third camera are acquired at the same time.

S302, determining first posture information of the second camera and the third camera according to the first posture information of the first camera, and the external parameters of the second camera and the third camera with respect to the first camera.

In an optional embodiment, the first posture information Pᵣ^{1,i} of the first camera before the smoothing of an ith frame is determined; and according to the first posture information of the first camera, and the external parameters P₁₂ and P₁₃ of the second camera and the third camera with respect to the first camera, the first posture information Pᵣ^{2,i}=P₁₂*Pᵣ^{1,i} of the second camera before the smoothing of the ith frame and the first posture information Pᵣ^{3,i}=P₁₃*Pᵣ^{1,i} of the third camera before the smoothing of the ith frame are determined.

S304, correcting video data acquired by the first camera, and acquiring motion compensation information of the first camera.

In an optional embodiment, smoothing processing is performed on the video data acquired by the first camera, so as to obtain a second posture parameter of the first camera after the smoothing of the i^{th} frame, which is denoted as Pᵥ^{1,i}; and the motion compensation information between a first posture parameter Pᵣ^{1,i} of the first camera before smoothing to the second posture parameter Pᵥ^{1,i} after smoothing is taken as basic information, which is denoted as M_{c}=Pᵥ^{1,i}*Pᵣ^{1,i}^{^{−1}}.

In an optional embodiment, the smoothing processing may be performed on the video data acquired by the first camera in manners such as low-pass filtering and objective function optimization; and the motion compensation information M_{c} between the first posture parameter Pᵣ^{1,i} of the first camera before smoothing to the second posture parameter Pᵥ^{1,i} after smoothing is acquired as the basic information by using a motion sensor such as a gyroscope, an accelerometer and a magnetometer.

S306, acquiring second posture information of the second camera and the third camera according to the motion compensation information of the first camera, and the first posture information of the second camera and the third camera.

In an optional embodiment, according to the motion compensation information M_{c} of the first camera and the first posture information Pᵣ^{2,i} and Pᵣ^{3,i} of the second camera and the third camera before the smoothing of the i^{th} frame, the second posture information Pᵥ^{2,i} and Pᵥ^{3,i} of the second camera and the third camera after the smoothing of the i^{th} frame are respectively acquired, wherein Pᵥ^{2,i}=M_{c}*Pᵣ^{2,i}, Pᵥ^{3,i}=M_{c}*Pᵣ^{3,i}.

S308, according to the internal parameters, the first posture information and the second posture information of the second camera and the third camera, respectively correcting the video data acquired by the second camera and the third camera, so as to obtain a processing result.

In an optional embodiment, the step S308 is specifically described by taking, as an example, how to correct the video data acquired by the second camera according to the internal parameters, the first posture information and the second posture information of the second camera.

There is a corresponding relationship between a world coordinate point and an image coordinate point in an imaging model of a camera:

xᵣ=K^{2,i}*Pᵣ^{2,i}*X

where, xᵣ=[uᵢ,vᵢ,1]⁻¹ represents a coordinate point in a video image of the second camera before the smoothing of the ith frame, and a corresponding point in a world coordinate system is X=[X, Y, Z]⁻¹, and K^{2,i} represents an internal parameter matrix of the second camera before the smoothing of the i^{th} frame:

$${K}^{2 , i} = \vert \begin{matrix}{f}_{x}^{2 , i} & 0 & {c}_{x}^{2. i} \\ 0 & {f}_{y}^{2 , i} & {c}_{y}^{2 , i} \\ 0 & 0 & 1\end{matrix} \vert$$

fₓ^{2,i}, f_{y}^{2,i}, cₓ^{2,i} and c_{y}^{2,i} respectively represent focal length and optical center position coordinates of an image in an XY direction, the image is generated by the second camera before the smoothing of the i^{th} frame.

With xᵥ as the coordinates of a corresponding point of a world coordinate point X in the video image after the smoothing of the i^{th} frame, the relationship between the image coordinate points of the second camera before and after the smoothing of the i^{th} frame is:

xᵥ=K^{2,i}*M_{c}*xᵣ=K^{2,i}*Pᵥ^{2,i}*Pᵣ^{2,i}^{^{−1}}*K^{2,i}^{^{−1}}*xᵣ

Subsequently, the actual video data acquired by the second camera is corrected according to the above corresponding relationship, so as to obtain smoothed video data.

Based on this, image stabilization processing of the video data acquired by the second camera is implemented. Similarly, image stabilization processing may be performed on the video data acquired by the third camera in the same manner.

In the existing multi-path video image stabilization processing methods, a plurality of motion sensors are usually required to acquire motion information of a plurality of camera units, and the motion information obtained by each motion sensor needs to be processed to obtain motion compensation information, which increases the volume, the cost and the calculation amount of the electronic device, thus increasing the requirements on the performance and power consumption of the electronic device.

By means of the above steps, it is only necessary to acquire the motion information of the basic camera unit through the motion sensor that corresponds to the basic camera unit, and then the video data acquired by the remaining camera units may be corrected, thus saving the performance and power consumption of a multi-camera platform.

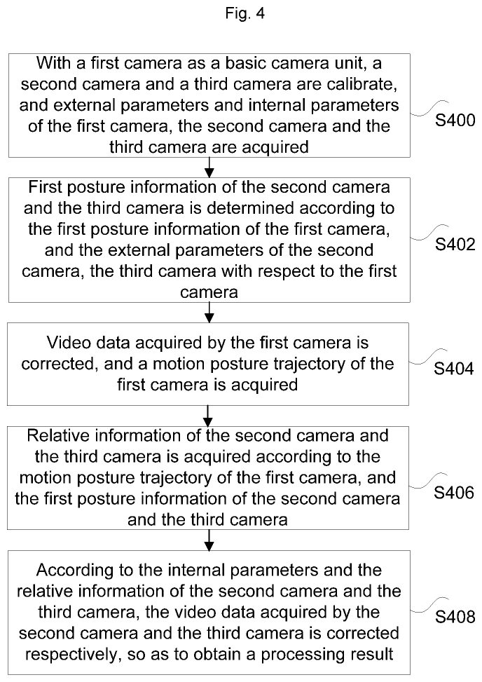

Referring to FIG. 4, it is a flowchart of the above steps S200-S206 applied to three-path video deblurring according to an embodiment of the present invention, which includes the following steps:
S400, with a first camera as a basic camera unit, calibrating a second camera and a third camera, and acquiring external parameters and internal parameters of the first camera, the second camera and the third camera.

In an optional embodiment, posture information of the three cameras during calibration are respectively denoted as P_{c}¹, P_{c}² and P_{c}³. With the first camera as a basic camera, the second camera and the third camera are calibrated with respect to the first camera, relative posture information P₁₂=P_{c}²*P_{c}¹^{^{−1}} and P₁₃=P_{c}³*P_{c}¹^{^{−1}} are determined as the external parameters, and focal lengths, optical center positions and other internal parameters of the first camera, the second camera and the third camera are acquired at the same time.

S402, determining first posture information of the second camera and the third camera according to the first posture information of the first camera, and the external parameters of the second camera and the third camera with respect to the first camera.

In an optional embodiment, the first posture information Pᵣ^{1,i} of the first camera at an i^{th} frame is determined; and according to the first posture information of the first camera, and the external parameters P₁₂ and P₁₃ of the second camera and the third camera with respect to the first camera, the first posture information Pᵣ^{2,i}=P₁₂*Pᵣ^{1,i} of the second camera at the i^{th} frame and the first posture information Pᵣ^{3,i}=P₁₃*Pᵣ^{1,i} of the third camera at the i^{th} frame are determined.

S404, correcting video data acquired by the first camera, and acquiring a motion posture trajectory of the first camera.

In an optional embodiment, the motion posture trajectory of the basic camera unit within an exposure time of the i^{th} frame is acquired as the basic information by using a motion sensor such as a gyroscope, an accelerometer and a magnetometer.

For example, according to the data of the gyroscope, rotation posture information of the basic camera unit within a period of exposure time may be obtained, and is approximately expressed as φₜ=φₜ_{ᵢ}+ω*(t−tᵢ), t∈[tᵢ, tᵢ+tₑₓₚ], where φₜ represents the rotation posture information of the basic camera unit at a certain exposure time t, tᵢ represents the time when the exposure of the ith frame starts, tₑₓₚ represents the duration of the exposure of the i^{th} frame, and ω represents an angular velocity of the motion of the basic camera unit. Accordingly, the motion posture trajectory of the basic camera unit within the exposure time during a video image generation process of the i^{th} frame can be obtained: Pᵣ^{1,i}(t), t∈[tᵢ, tᵢ+tₑₓₚ].

In S402, the first posture information Pᵣ^{1,i} of the basic camera described of the i^{th} frame corresponds to a posture Pᵣ^{1,i}(tᵢ+t_{c}) that is selected at a certain reference time t_{c} in the i^{th} frame of video, which indicates that the posture corresponding to a specific moment t_{c} during the image generation process is used as a reference posture of the current video frame, that is, corresponds to the posture information of a certain row. Generally, t_{c} may be set to be 0, which indicates selecting a generation starting moment of a first row of images.

S406, acquiring relative information of the second camera and the third camera according to the motion posture trajectory and the first posture information of the basic camera unit.

In an optional embodiment, the motion posture trajectory Pᵣ^{2,i}(t)=P₁₂*Pᵣ^{1,i}(t) of the second camera unit within the exposure time of the i^{th} frame of video image is acquired according to the motion posture trajectory and the external parameters of the basic camera unit, and the relative information ∇Pᵣ^{2,i}(t)=Pᵣ^{2,i}(t)*Pᵣ^{2,i}^{^{−1}} corresponding to the first posture information of the current frame within the exposure time period is further acquired according to the first posture information of the second camera; and similarly, the motion posture trajectory Pᵣ^{3,i}(t)=P₁₃*Pᵣ^{1,i}(t) of the third camera unit within the exposure time of the i^{th} frame of video image is acquired according to the motion posture trajectory and the external parameters of the basic camera unit, and the relative information ∇Pᵣ^{3,i}(t)=Pᵣ^{3,i}(t)*Pᵣ^{3,i}^{^{−1}} corresponding to the first posture information of the current frame within the exposure time period is further acquired according to the first posture information of the third camera.

S408, according to the internal parameters and the relative information of the second camera and the third camera, respectively correcting the video data acquired by the second camera and the third camera, so as to obtain a processing result.

Taking the second camera as an example, an exposure starting moment is denoted as tᵢ, and an exposure duration is denoted as tₑₓₚ, then a point spread function C(tᵢ, tₑₓₚ)=∫ₜ₌ₜ_{ᵢ}^{t}^{ᵢ}^{+t}^{ₑₓₚ}K^{2,i}*∇Pᵣ^{2,i}(t) within the exposure duration tₑₓₚ starting from the moment tᵢ may be calculated according to the internal parameters and the relative information of the second camera.

K^{2,i} represents an internal parameter matrix corresponding to the second camera at the i^{th} frame:

$${K}^{2 , i} = \vert \begin{matrix}{f}_{x}^{2 , i} & 0 & {c}_{x}^{2. i} \\ 0 & {f}_{y}^{2 , i} & {c}_{y}^{2 , i} \\ 0 & 0 & 1\end{matrix} \vert .$$

fₓ^{2,i}, f_{y}^{2,i}, cₓ^{2,i} and c_{y}^{2,i} respectively represent focal length and optical center position coordinates of an image in an XY direction, which is generated by the second camera at the i^{th} frame. In an actual processing process, the point spread function is discretized and mapped onto a two-dimensional image coordinate axis, so as to obtain a blur kernel, and then the blur kernel is used to process data generated by the second camera in manners such as deconvolution operation, so that motion blur in a video is reduced.

The point spread function depends on the motion posture trajectory of the basic camera unit within the exposure time, and calculates the blur kernel by using the motion posture trajectory as the basic information, thereby realizing the deblurring processing of the video data acquired by the second camera. Similarly, deblurring processing of the video data acquired by the remaining cameras may be completed in the same way.

In another embodiment, in view of the problem that different areas of the image have different starting and ending times of exposure time, different blur kernels may be calculated for different areas of the image, so as to further improve the accuracy of processing the motion blur.

Repeated calculation of relative motion trajectories is reduced in the whole processing process, and a deblurring function of a plurality of paths of concurrent videos may be realized.

In addition, those skilled in the art will know that by means of the above method, by means of removing the relative motion between different pixel positions during a video generation process, it is also possible to eliminate a rolling shutter (Rolling Shutter) effect caused by line-by-line exposure of a CMOS sensor camera.

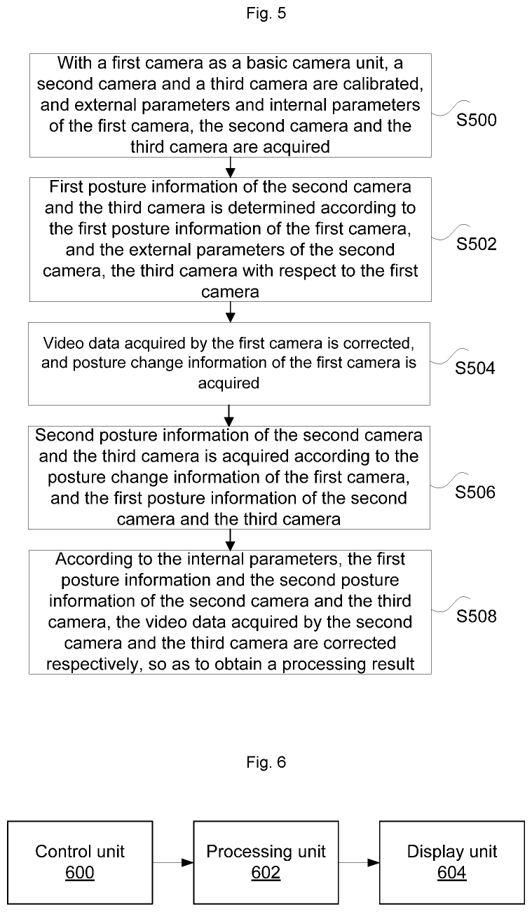

Referring to FIG. 5, it is a flowchart of the above steps S200-S206 applied to three-path video denoising according to an embodiment of the present invention, which includes the following steps:
S500, with a first camera as a basic camera unit, calibrating a second camera and a telephoto camera, and acquiring external parameters and internal parameters of the first camera, the second camera and a third camera.

In an optional embodiment, posture information of the three cameras during calibration are respectively denoted as P_{c}¹, P_{c}² and P_{c}³. With the first camera as a basic camera, the second camera and the third camera are calibrated with respect to the first camera, relative posture information P₁₂=P_{c}²*P_{c}¹^{^{−1}} and P₁₃=P_{c}³*P_{c}¹^{^{−1}} are determined as the external parameters, and focal lengths, optical center positions and other internal parameters of the first camera, the second camera and the third camera are acquired at the same time.

S502, determining first posture information of the second camera and the third camera according to the first posture information of the first camera, and the external parameters of the second camera and the third camera with respect to the first camera.

In an optional embodiment, the first posture information Pᵣ^{1,i} of the first camera at an i^{th} frame is determined; and according to the first posture information of the first camera, and the external parameters P₁₂ and P₁₃ of the second camera and the third camera with respect to the first camera, the first posture information Pᵣ^{2,i}=P₁₂*Pᵣ^{1,i} of the second camera at the i^{th} frame and the first posture information Pᵣ^{3,i}=P₁₃*Pᵣ^{1,i} of the third camera at the i^{th} frame are determined.

S504, correcting video data acquired by the first camera, and acquiring posture change information of the first camera.

In an optional embodiment, denoising processing is performed on the video data acquired by the first camera, and the content of the current frame is corrected by using the data of previous and subsequent frames. A second posture parameter of the first camera at an (i+1)^{th} frame is denoted as Pᵣ^{1,i+1}; and the posture change information M r of the first camera between the first posture parameter Pᵣ^{1,i} at the i^{th} frame and the second posture parameter Pᵣ^{1,i+1} at the (i+1)^{th} frame is acquired as basic information, and is denoted as Mᵣ=Pᵣ^{1,i+1}*Pᵣ^{1,i}^{^{−1}}.

In an optional embodiment, the denoising processing may be performed on the video data acquired by the first camera by using similar filtering methods such as weighted summation; and the posture change information Mᵣ of the first camera between the first posture parameter Pᵣ^{1,i} at the ith frame and the second posture parameter Pᵣ^{1,i+1} at the (i+1)^{th} frame may be acquired as the basic information by using a motion sensor such as a gyroscope, an accelerometer and a magnetometer.

S506, acquiring second posture information of the second camera and the third camera according to the posture change information of the first camera, and the first posture information of the second camera and the third camera.

In an optional embodiment, according to the posture change information Mᵣ of the first camera and the first posture information Pᵣ^{2,i} and Pᵣ^{3,i} of the second camera and the third camera at the i^{th} frame, the second posture information Pᵣ^{2,i+1} and Pᵣ^{3,i+1} of the second camera and the third camera at the (i+1)^{th} frame are acquired respectively, wherein Pᵣ^{2,i+1}=Mᵣ*Pᵣ^{2,i}, Pᵣ^{3,i+1}=Mᵣ*Pᵣ^{3,i}.

In another optional embodiment, more accurate posture change information Mᵣ may be obtained through further image alignment, so as to further correct the second posture information of the second camera and the third camera.

S508, according to the internal parameters, the first posture information and the second posture information of the second camera and the third camera, respectively correcting the video data acquired by the second camera and the third camera, so as to obtain a processing result.

In an optional embodiment, the step S508 is specifically described by taking, as an example, how to correct the video data acquired by the second camera according to the internal parameters, the first posture information and the second posture information of the second camera.

There is a corresponding relationship between a world coordinate point and an image coordinate point in an imaging model of a camera:

xᵣ=K^{2,i}*Pᵣ^{2,i}*X

where, xᵣ=[uᵢ, vᵢ, 1]⁻¹ represents a coordinate point in a video image of the second camera at the i^{th} frame, and a corresponding point in a world coordinate system is X=[X, Y, Z]⁻¹, and K^{2,i} represents an internal parameter matrix of the second camera at a moment i:

$${K}^{2 , i} = \vert \begin{matrix}{f}_{x}^{2 , i} & 0 & {c}_{x}^{2. i} \\ 0 & {f}_{y}^{2 , i} & {c}_{y}^{2 , i} \\ 0 & 0 & 1\end{matrix} \vert$$

fₓ^{2,i}, f_{y}^{2,i}, cₓ^{2,i} and c_{y}^{2,i} respectively represent focal length and optical center position coordinates of an image in an XY direction, which is generated by the second camera at the i^{th} frame.

With xᵣⁱ⁺¹ as the coordinates of a corresponding point of a world coordinate point X in the video image of the (i+1)^{th} frame, and K^{2,i+1} as the internal parameter matrix of the second camera after the smoothing of the (i+1)^{th} frame, the relationship between the image coordinate points of the second camera at the i^{th} frame and the (i+1)^{th} frame is: xᵣⁱ⁺¹=K^{2,i+1}*Pᵣ^{2,i+1}*Pᵣ^{2,i}^{^{−1}}*K^{2,i}^{^{−1}}*xᵣⁱ.

Similarly, it is also possible to acquire pixel positions of more previous and subsequent frames of the second camera corresponding to xᵣⁱ, such as xᵣⁱ⁻², xᵣⁱ⁻¹ and xᵣⁱ⁺². Subsequently, the content of xᵣⁱ is corrected by performing operations, such as weighted averaging, on the data of the corresponding coordinates, so as reduce the noise of the ith frame of image in the video.

Based on this, denoising processing of the video data acquired by the second camera is implemented. Similarly, the video data acquired by the remaining cameras may be processed in the same way.

In another embodiment, it is also possible to establish a corresponding relationship between images of different camera units through external parameter information between different camera units, and the current frame of the processed camera is further corrected by using the data of corresponding frames and the data of previous and subsequent frames of different cameras, so as to implement a denoising function.

During the processing, a plurality of calculations of alignment information are avoided, and the denoising processing performance of a plurality of paths of concurrent videos of the multi-camera platform may be effectively optimized.

In addition, those skilled in the art will know that, the above method may also be used for implementing processing such as superfine division of the video.

Of course, those skilled in the art will know that the three cameras are only taken as an example for the convenience of description, and the above method may also be extended to an application scenario of a plurality of cameras.

In another practical application scenario, during video preview, only one path or several paths of video data may be output to a display interface at a certain moment, which may be called display data, and other video data that is not displayed may be called non-display data. Based on this, a correction function of the camera corresponding to the non-display data may be selectively turned off, and only the display data is corrected to actually generate a required corrected video image, thereby further saving the performance and power consumption of the multi-camera platform. For example, when the user uses an electronic device with an ultra-wide-angle camera, a wide-angle camera and a telephoto camera for video or photo photographing, only videos or photos acquired by the ultra-wide-angle camera are processed and displayed, or only videos or photos acquired by the wide-angle camera and the telephoto camera are processed and displayed according to the selection of the user, etc.

In another practical application scenario, after a plurality of paths of video data are corrected, the plurality of paths of video data may be spliced and are displayed on the display interface at the same time. Part or all of the plurality of paths of video data may be displayed in an independent display form on different areas of the display interface, or part or all of the plurality of paths of video data are displayed in an overlapping display manner on different areas of the display interface, or part or all of the plurality of paths of video data are displayed in a fusion display manner on different areas of the display interface. For example, in an electronic device with front and rear cameras, selfie portrait information is acquired by using a front scenario, scenario information is acquired by using a rear scenario, then the information acquired by the front camera and the rear camera is corrected and presented on the display interface at the same time, and the information of a field of view of the front camera and the information of the field of view of the rear camera are recorded at the same time, thereby avoiding the problem in the related art that, the front scenario or the rear scenario may only be recorded separately, or the front scenario and the rear scenario, which are asynchronous, may only be acquired and then are spliced together instead of synchronously acquiring and processing front scenario data and rear scenario data.

According to another aspect of the embodiments of the present invention, an electronic device is also provided, including: a processor; and a memory for storing executable instructions of the processor, wherein the processor is configured to execute any one of the above video processing methods by means of executing the executable instructions.

According to another aspect of the embodiments of the present invention, a non-transitory computer readable storage medium is also provided, including a stored program, wherein when the program runs, a device where the non-transitory computer readable storage medium is located is controlled to execute any one of the above video processing methods.

According to another aspect of the embodiments of the present invention, a video processing apparatus is also provided. Referring to FIG. 6, it is a structural block diagram of an optional video processing apparatus according to an embodiment of the present invention. As shown in FIG. 6, the video processing apparatus 60 includes a control unit 600, a processing unit 602 and a display unit 604.

Each unit contained in the video processing device 60 will be described in detail below.

The control unit 600 is configured to control N camera units in an electronic device to be simultaneously turned on, so as to acquire N paths of video data.

In an optional embodiment, the electronic device may be a video camera, a smart phone, a mobile phone, a computer, a tablet computer, a desktop computer, a television, a vehicle, a remote control aircraft, a healthcare device, a set-top box and the like, which have a plurality of camera units. The N camera units may be of the same type, for example, all are common RGB cameras; and may also be of different types, such as combinations of two or more of a common RGB camera, an ultra-wide-angle camera, a wide-angle camera, a telephoto camera, an infrared camera, a depth camera and other cameras. The N camera units are controlled by the same control unit, and the control unit may be the same chip, the same sensor, and so on.

The processing unit 602 is configured to obtain a processing result by processing a plurality of paths of video data in the N paths of video data; and
the display unit 604 is configured to display the processing result on a display screen of the electronic device.

By means of the above video processing apparatus, N paths of video data may be acquired simultaneously, and the N camera units are only controlled by the same control unit, such that the cost and the volume of the electronic device can be reduced.

In the related art, if a user wants to display his/her own portrait and a background at the same time, he/she usually takes a selfie after selecting a scenario. However, in this way, since the user is relatively close to the camera when taking the selfie, a selfie portrait will occupy a relatively large proportion in an entire picture, which is easy to shield the selected scenario, and thus it is difficult to present the selfie portrait and the background with a better effect. By using the above video processing apparatus, the user may turn on front and rear cameras at the same time when using the electronic device, so as to acquire a front scenario and a rear scenario at the same time, thus enriching video information. Moreover, the user may add his/her own expressions and languages while photographing the rear scenario, so that the mood, feeling, author information and the like of the user are recorded in real time with the scenarios, and it is unnecessary to worry about the problems of shielding the selected scenario and data asynchronization.

In an optional embodiment, the processing unit 602 further includes:
a first processing sub-unit 6020, configured to select one of the N camera units as a basic camera unit, correct the video data acquired by the basic camera unit, and acquire basic information of the basic camera unit.

In an optional embodiment, if the N camera units are all image cameras, a camera with a greater angle of field of view may be selected as the basic camera unit, so as to contain external information as much as possible; if the N camera units contain a depth camera, when applied to portrait photographing, depth reconstruction and other photographing scenarios that rely more on depth information, the depth camera may be selected as the basic camera unit; and if the N camera units contain an infrared camera, when applied to a night vision environment, infrared tracking and other photographing scenarios that rely more on infrared information, the infrared camera may be selected as the basic camera unit. Only some examples of selecting the basic camera unit are given above, and those skilled in the art may select one of the N camera units as the basic camera unit according to actual application scenarios.

In different application scenarios, the video data acquired by the basic camera unit may be corrected in different modes, for example, image stabilization processing, denoising processing, deblurring processing, brightening processing, and so on. Correspondingly, different information may be acquired as the basic information, for example, during image stabilization processing, motion compensation information of the basic camera unit may be acquired as the basic information; during deblurring processing, a motion posture trajectory of the basic camera unit may be acquired as the basic information; and during denoising processing, posture changes in previous and subsequent frames of the basic camera unit may be acquired as the basic information. Of course, the above description is only an example of the basic information that is acquired according to different application scenarios, and those skilled in the art may also acquire reasonable basic information according to actual needs.

In an optional embodiment, the basic information of the basic camera unit may be acquired by using an information acquisition unit (e.g., a motion posture sensor such as a gyroscope, an accelerometer and a magnetometer).

A second processing sub-unit 6022, configured to correct, according to the basic information of the basic camera unit, M paths of video data that are acquired by the remaining M camera units in the N camera units.

In an optional embodiment, the second processing sub-unit 6022 includes:
a second posture acquisition unit, configured to respectively acquire second posture information of the M camera units according to the basic information of the basic camera unit and first posture information of the M camera units; and
a correction unit, configured to respectively correct the M paths of video data according to internal parameters, the first posture information and the second posture information of the M camera units.

In another optional embodiment, the second processing sub-unit 6022 includes:
a relative information acquisition unit, configured to respectively acquire relative information of the M camera units according to the basic information of the basic camera unit and first posture information of the M camera units; and
a correction unit, configured to respectively correct the M paths of video data according to the internal parameters and the relative information of the M camera units.

In an optional embodiment, the second processing sub-unit 6022 further includes:
a calibration unit, configured to calibrate the M camera units with the basic camera unit as a reference, and acquire external parameters and internal parameters of the M camera units and the basic camera unit; and
a first posture acquisition unit, configured to determine the first posture information of the M camera units according to the first posture information of the basic camera unit, and the external parameters of the M camera units and the basic camera unit.

In an optional embodiment, the step of calibrating the M camera units, and acquiring the external parameters and the internal parameters of the M camera units and the basic camera unit includes: with the basic camera unit as the reference, calculating a relative position relationship between the M camera units and the basic camera unit, so as to acquire the external parameters of the M camera units, and to acquire the internal parameters of the M camera units and the basic camera unit at the same time. Specifically, the external parameters include direction features and position features, the direction features of the camera units may be recorded by using a rotation matrix, and the position features of the camera units may be recorded by using a translation matrix. The internal parameters include a focal length, an optical center position, etc.

A result acquisition unit 6024, configured to take the corrected video data of the basic camera unit and the M camera units as the processing result.

By means of a video processing apparatus constructed on the basis of the above processing apparatus, it is not necessary to equip the M camera units with respective information acquisition units to acquire M pieces of basic information, but only one basic camera unit needs to be selected, and the basic information of the basic camera unit is acquired by means of an information acquisition unit corresponding to the basic camera unit, such that it is possible to correct the M paths of video data that are acquired by the remaining M camera units in the N camera units, and image stabilization, deblurring, denoising, brightening and other processing of a plurality of paths of concurrent videos are realized. Therefore, the number of information acquisition units in the electronic device may be reduced, and the volume, cost and calculation amount of the electronic device may be further reduced, thus reducing requirements on the performance and power consumption of the electronic device.

The serial numbers of the above embodiments of the present invention are only for description, but do not represent the advantages or disadvantages of the embodiments.

In the above embodiments of the present invention, the description of each embodiment has its own emphasis. For parts that are not described in detail in a certain embodiment, reference may be made to related descriptions of other embodiments.

In the several embodiments provided by the present application, it should be understood that, the disclosed technical content may be implemented in other manners. The apparatus embodiments described above are merely exemplary, for example, the division of the units may be a logic function division, there may be other division manners in practical implementation, for example, a plurality of units or components may be combined or integrated to another system, or some features may be omitted or not implemented. From another point of view, the displayed or discussed mutual coupling or direct coupling or communication connection may be indirect coupling or communication connection of units or modules through some interfaces, and may be in electrical or other forms.

The units described as separate components may be separated physically or not, components displayed as units may be physical units or not, namely, may be located in one place, or may be distributed on a plurality of units. Part or all of the units may be selected to implement the purposes of the solutions in the present embodiment according to actual demands.

In addition, functional units in various embodiments of the present invention may be integrated in a processing unit, or the units individually exist physically, or two or more units are integrated in one unit. The integrated unit may be implemented in the form of hardware, and may also be implemented in the form of a software functional unit.

If the integrated unit is implemented in the form of the software functional unit and is sold or used as an independent product, it may be stored in a computer-readable non-transitory computer readable storage medium. Based on this understanding, the technical solutions of the present invention substantially, or the part contributing to the prior art, or all or part of the technical solutions may be embodied in the form of a software product, the computer software product is stored in a non-transitory computer readable storage medium, and includes several instructions for enabling a computer device (which may be a personnel computer, a server, or a network device or the like) to execute all or part of the steps of the method in various embodiments of the present invention. The foregoing non-transitory computer readable storage medium includes a variety of media capable of storing program codes, such as a USB disk, a read-only memory (ROM, Read-Only Memory), a random access memory (RAM, Random Access Memory), a mobile hard disk, a magnetic disk, or an optical disk.

The foregoing descriptions are merely specific embodiments of the present invention. It should be pointed out that, those of ordinary skill in the art may make several improvements and modifications without departing from the principles of the present invention, and these improvements and modifications should also be regarded as the protection scope of the present invention.

### INDUSTRIAL APPLICABILITY

The solutions provided by the embodiments of the present application can realize that data collected by a plurality of cameras can be acquired at the same time. The technical solutions provided in the embodiments of the present application can be applied to related electronic devices for image processing. The user may turn on front and rear cameras at the same time when using the electronic device, so as to acquire a front scenario and a rear scenario at the same time, thus enriching video information. Moreover, the user may add his/her own expressions and languages while photographing the rear scenario, so that the mood, feeling, author information and the like of the user are recorded in real time with the scenarios, and it is unnecessary to worry about the problems of shielding the selected scenario and data asynchronization. Further, in the present application, a user may selectively turn off a correction function of the camera corresponding to the non-display data, and only the display data is corrected to actually generate a required corrected video image, thereby further saving the performance and power consumption of the multi-camera platform. For example, when the user uses an electronic device with an ultra-wide-angle camera, a wide-angle camera and a telephoto camera for video or photo photographing, only videos or photos acquired by the ultra-wide-angle camera are processed and displayed, or only videos or photos acquired by the wide-angle camera and the telephoto camera are processed and displayed according to the selection of the user, etc.

1. A video processing method, comprising:
controlling N camera units in one electronic device to simultaneously acquire N paths of video data, wherein the N camera units are simultaneously turned on under a control of a same control unit in the electronic device, and N is an integer not less than 2;
obtaining a processing result by processing a plurality of paths of video data in the N paths of video data; and
displaying the processing result on a display screen of the electronic device.

2. The video processing method as claimed in claim 1, wherein the step of obtaining a processing result by processing a plurality of paths of video data in the N paths of video data comprises:
selecting one of the N camera units as a basic camera unit, correcting the video data acquired by the basic camera unit, and acquiring basic information of the basic camera unit;
correcting, according to the basic information of the basic camera unit, M paths of video data that are acquired by the remaining M camera units in the N camera units; and
taking the corrected video data of the basic camera unit and the M camera units as the processing result.

3. The video processing method as claimed in claim 2, wherein the step of correcting, according to the basic information of the basic camera unit, M paths of video data that are acquired by the remaining M camera units in the N camera units comprises:
respectively acquiring second posture information of the M camera units according to the basic information of the basic camera unit and first posture information of the M camera units; and
respectively correcting the M paths of video data according to internal parameters, the first posture information and the second posture information of the M camera units.

4. The video processing method as claimed in claim 2, wherein the step of correcting, according to the basic information of the basic camera unit, M paths of video data that are acquired by the remaining M camera units in the N camera units comprises:
respectively acquiring relative information of the M camera units according to the basic information of the basic camera unit and first posture information of the M camera units; and
respectively correcting the M paths of video data according to the internal parameters and the relative information of the M camera units.

5. The video processing method as claimed in claim 3, further comprising:
calibrating the M camera units with the basic camera unit as a reference, and acquiring external parameters and internal parameters of the M camera units and the basic camera unit; and
determining the first posture information of the M camera units according to the first posture information of the basic camera unit, and the external parameters of the M camera units and the basic camera unit.

6. The video processing method as claimed in claim 2, wherein the method for correcting the video data acquired by the basic camera unit and the M paths of video data acquired by the M camera units comprises at least one of image stabilization processing method, deblurring processing method, denoising processing method, and brightening processing method.

7. The video processing method as claimed in claim 2, wherein the basic information of the basic camera unit comprises at least one of motion compensation information, a motion posture trajectory, and posture changes in previous and subsequent frames.

8. The video processing method as claimed in claim 5, wherein the internal parameters comprise a focal length and an optical center position.

9. The video processing method as claimed in claim 5, wherein the step of calibrating the M camera units with the basic camera unit as the reference, and acquiring the external parameters of the M camera units and the basic camera unit comprises: with the basic camera unit as the reference, calculating a relative position relationship between the M camera units and the basic camera unit, so as to acquire the external parameters of the M camera units.

10. The video processing method as claimed in claim 5, wherein the external parameters comprise direction features and position features, the direction features of the camera units are recorded by using a rotation matrix, and the position features of the camera units are recorded by using a translation matrix.

11. The video processing method as claimed in claim 2, wherein the basic information of the basic camera unit is obtained by a motion sensor, and the motion sensor comprises at least one of a gyroscope, an accelerometer and a magnetometer.

12. The video processing method as claimed in claim 2, wherein the step of correcting the video data acquired by the basic camera unit comprises: performing discrete sampling on a motion posture trajectory of the basic camera unit within a continuous time period, so as to obtain a point spread function or a blur kernel, and then obtaining deblurred video data by means of deconvolution.

13. The video processing method as claimed in claim 1, wherein the step of obtaining a processing result by processing a plurality of paths of video data in the N paths of video data comprises: performing splicing processing on at least two paths of video data in the N paths of video data, and taking the spliced video data as the processing result.

14. (canceled)

15. (canceled)

16. (canceled)

17. (canceled)

18. (canceled)

19. (canceled)

20. A non-transitory computer readable storage medium storing instructions which, when executed by one or more processors, cause the one or more processors to perform operations comprising:
controlling N camera units in one electronic device to simultaneously acquire N paths of video data, wherein the N camera units are simultaneously turned on under a control of a same control unit in the electronic device, and N is an integer not less than 2;
obtaining a processing result by processing a plurality of paths of video data in the N paths of video data; and
displaying the processing result on a display screen of the electronic device.

21. An electronic device, comprising:
a processor; and
a memory for storing executable instructions of the processor,
wherein the processor is configured to execute the video processing method as following;
controlling N camera units in one electronic device to simultaneously acquire N paths of video data, wherein the N camera units are simultaneously turned on under a control of a same control unit in the electronic device, and N is an integer not less than 2;
obtaining a processing result by processing a plurality of paths of video data in the N paths of video data; and
displaying the processing result on a display screen of the electronic device.

22. The video processing method as claimed in claim 4, further comprising:
calibrating the M camera units with the basic camera unit as a reference, and acquiring external parameters and internal parameters of the M camera units and the basic camera unit; and
determining the first posture information of the M camera units according to the first posture information of the basic camera unit, and the external parameters of the M camera units and the basic camera unit.

23. The video processing method as claimed in claim 22, wherein the internal parameters comprise a focal length and an optical center position.

24. The video processing method as claimed in claim 22, wherein the step of calibrating the M camera units with the basic camera unit as the reference, and acquiring the external parameters of the M camera units and the basic camera unit comprises: with the basic camera unit as the reference, calculating a relative position relationship between the M camera units and the basic camera unit, so as to acquire the external parameters of the M camera units.

25. The video processing method as claimed in claim 22, wherein the external parameters comprise direction features and position features, the direction features of the camera units are recorded by using a rotation matrix, and the position features of the camera units are recorded by using a translation matrix.

26. The video processing method as claimed in claim 1, wherein the step of displaying the processing result on a display screen of the electronic device comprises:
selectively turning off a correction function of a camera corresponding to non-display data, and correcting only display data to actually generate a required corrected video image, wherein the display data is one path or several paths of video data output to a display interface at a certain moment during video preview, and the non-display data is other video data that is not displayed.
